(19) United States
(12) Patent Application Publication
(10) Pub. No.: US 2020/0259900 A1
(43) Pub. Date: Aug. 13, 2020

(54) DATA TRANSMISSION METHOD, SERVER, STORAGE SYSTEM, TERMINAL DEVICE, AND SYSTEM

(71) Applicant: SZ DJI TECHNOLOGY CO., LTD., Shenzhen (CN)

(72) Inventors: Chuantang XIONG, Shenzhen (CN); Liming FAN, Shenzhen (CN); Zhiqiang WU, Shenzhen (CN)

(21) Appl. No.: 16/859,533

(22) Filed: Apr. 27, 2020

Related U.S. Application Data
(63) Continuation of application No. PCT/CN2017/108466, filed on Oct. 31, 2017.

(51) Int. Cl. H04L 29/08; H04L 29/06

(52) U.S. Cl. CPC H04L 67/1097; H04W 4/44; H04L 63/083

(57) ABSTRACT

The present disclosure relates to a data transmission method applied to a server. The method includes receiving operation data of an unmanned aerial vehicle sent by a terminal device, and writing the received operation data to a storage system that refuses the server to read data stored in that storage system.

### CROSS-REFERENCE TO RELATED APPLICATION

The present disclosure is a continuation of International Application No. PCT/CN2017/108466, filed Oct. 31, 2017, the entire content of which is incorporated herein by reference.

### TECHNICAL FIELD

The present disclosure relates to the field of unmanned aerial vehicle and, more particularly, to a data transmission method, server, storage system, terminal device, and system.

### BACKGROUND

In the existing technologies, unmanned aerial vehicles (UAVs) have been applied in the fields of electric power inspection, security patrol, pipeline inspection, modeling, surveying, and mapping, etc.

During the operation of a UAV (such as surveying and mapping operations, inspection operations, etc.), its operation data may be uploaded to a cloud platform in real time, so that users may acquire the operation data of the UAV, such as image data, video data, status information of the UAV during operation, etc., from the cloud platform. In addition to the operation data of the UAV, the cloud platform may also store other data.

However, the cloud platform in the existing technologies is usually established by a cloud platform service provider. The platform service provider may access the data on the cloud platform. As a result, the data of the users stored in the cloud platform can be easily leaked, resulting in low data security.

### SUMMARY

In accordance with the present disclosure, there is provided a data transmission method applied to a server. The method includes receiving operation data of an unmanned aerial vehicle sent by a terminal device, and writing the received operation data to a storage system that refuses the server to read data stored in that storage system.

Also in accordance with the present disclosure, there is provided a server for data transmission. The server includes a communication interface and a processor. The communication interface is configured to receive operation data of a UAV sent by a terminal device. The processor is configured to write the received operation data through the communication interface to a storage system that refuses the server to read data stored in that storage system.

### BRIEF DESCRIPTION OF THE DRAWINGS

FIG. 1 is a schematic diagram of a data transmission system according to an embodiment of the present disclosure;

FIG. 2 is a flowchart of a data transmission method according to an embodiment of the present disclosure;

FIG. 3 is a schematic diagram of a data transmission system according to an embodiment of the present disclosure;

FIG. 4 is a flowchart of a data transmission method according to another embodiment of the present disclosure;

FIG. 5 is a flowchart of a data transmission method according to another embodiment of the present disclosure;

FIG. 6 is a flowchart of a data transmission method according to another embodiment of the present disclosure;

FIG. 7 is a flowchart of a data transmission method according to another embodiment of the present disclosure;

FIG. 8 is a flowchart of a data transmission method according to another embodiment of the present disclosure;

FIG. 9 is a schematic diagram of a user interface according to an embodiment of the present disclosure;

FIG. 10 is a schematic structural diagram of a server according to an embodiment of the present disclosure;

FIG. 11 is a schematic structural diagram of a storage system according to an embodiment of the present disclosure;

FIG. 12 is a schematic structural diagram of a server according to another embodiment of the present disclosure; and

FIG. 13 is a schematic structural diagram of a terminal device according to an embodiment of the present disclosure.

### DETAILED DESCRIPTION OF THE EMBODIMENTS

The technical solutions in the embodiments of the present disclosure will be made in detail hereinafter with reference to the accompanying drawings. Apparently, the disclosed embodiments are only a part, but not all, of the embodiments of the present disclosure. Other embodiments obtained by a person of ordinary skill in the art based on the embodiments of the present disclosure without creative efforts shall also fall within the protection scope of the present disclosure.

It should be noted that when a component is called “fixed” to another component, it may be directly attached to another component or be a centered component inside another component. When a component is considered to be “connected” to another component, it may be directly connected to another component or a centered component inside another component.

Unless specified otherwise, all technical and scientific terms used herein have the same meaning as commonly understood by one of ordinary skill in the relevant art. The terms used here in the description of the present disclosure are merely for the purpose of describing specific embodiments, and are not intended to limit the present disclosure. The term “and/or” as used herein includes any and all combinations of one or more of the associated listed items.

Embodiments of the present disclosure will be described in detail hereinafter with reference to the accompanying drawings. Unless there is an obvious conflict, the following embodiments and features in the disclosed embodiments may be combined with each other.

As shown in FIG. 1, the UAV 11 may be a UAV of user, where the user may be an individual user or a commercial user. The UAV 11 is equipped with a photographing device 111 through a gimbal 110. The UAV may perform tasks assigned to it by the user. For example, the UAV may perform tasks specified by the user, such as electric power inspection, security patrol, pipeline patrol, surveying, and modeling, etc. During the execution of the tasks, the photographing device 111 may capture image data or video data in real time.

Further, the UAV 11 sends the image data or video data acquired by the photographing device 111 in real time to a remote control 12 on the ground through its communication system. The remote control 12 is configured to control the flight of the UAV 11. The remote control 12 may also communicate with a terminal device 13. The terminal device 13 may be a terminal device, with a communication function, carried by a field operator such as a pilot. The communication method between the remote control 12 and the terminal device 13 may be a wired communication or wireless communication. Through the communication between the remote control 12 and the terminal device 13, the remote control 12 sends the received image data or video data, sent by the UAV 11, to the terminal device 13. The terminal device 13 is a ground terminal device. In actual applications, the terminal device may be specifically a mobile phone, a tablet, a laptop, etc.

Alternatively, the UAV 11 may directly communicate with the terminal device 13 wirelessly. For instance, the UAV 11 directly sends the image data or video data, acquired by the photographing device 111 in real time, to the terminal device 13 through its communication system.

Optionally, the UAV 11 encodes the image data or video data, acquired by the photographing device 111 in real time, to get the encoded image data or encoded video data, and sends the encoded image data or encoded video data to the ground remote control 12. The remote control 12 sends the encoded image data or encoded video data to the terminal device 13. Alternatively, the UAV 11 may directly send the encoded image data or encoded video data to the terminal device 13.

After receiving the encoded image data or encoded video data, the terminal device 13 may decode the encoded image data or encoded video data to obtain decoded image data or decoded video data. Further, the terminal device 13 may also encode the decoded image data or decoded video data into image data or video data in different formats. For example, the terminal device 13 encodes the decoded image data or decoded video data into image data or video data in the RTMP (real time messaging protocol) format.

Further, the terminal device 13 sends the image data or video data in the RTMP format to the cloud platform, such as a server 15, through a base station 14. The server 15 may be a service server provided by the cloud platform service provider. The disclosed embodiment does not limit the number of the server 15. The server 15 may store image data or video data in a public storage system 17.

It is to be understood that a remote terminal device 16 may include different kinds of devices, such as an iOS® device and an Android® device. The iOS device and the Android device may support different formats of image data or video data. The iOS devices, such as iPhones, iMacs, iPads, support HLS (HTTP live streaming) format image data or video data. The Android devices, such as Android phones, and computers using Windows systems support RTMP and M3U8 (MP3 playlist file (UTF-8)) format image data or video data.

If the remote terminal device 16 is an iOS device such as an iPhone, iMac, etc. when the server 15 receives the RTMP format image data or video data sent by the terminal device 13, the server 15 also needs to convert the RTMP format image data or video data into image data or video data in the HLS format, and stores the image data or video data in the HLS format in the public storage system 17. Further, the server 15 generates an access address of the image data or video data in the HLS format. The access address may be an image or video acquisition address in the HLS format.

The server 15 may send the access address to the remote terminal device 16. The remote terminal device 16, such a device of the iOS system, acquires the image data or video data in the HLS format from the server 15 according to the image or video acquisition address in the HLS format.

Alternatively, the server 15 may also send the access address to a server 19, and it is the server 19 that sends the access address corresponding to the image data or video data to the remote terminal device 16. The remote terminal device 16 such as a device of the iOS system acquires the image data or video data in HLS format from the server 15 according to the image or video acquisition address in the HLS format.

In addition, a user may also edit route data of the UAV 11 through the remote terminal device 16. The remote terminal device 16 sends the route data of the UAV 11 edited by the user to the server 15. The server 15 further stores the user-edited route data of the UAV 11 in the public storage system 17. Alternatively, the operator of the UAV 11, that is, the pilot of the UAV 11, may edit the route of the UAV 11 on the terminal device 13, and control the UAV 11 to fly according to the edited route. The terminal device 13 may send the route data to the server 15, and the server 15 stores the route data in the public storage system 17.

It is to be understood that the server 15 has all the privileges for the public storage system 17. For example, the server 15 may access all the storage space/area of the public storage system 17. The server 15 may write data to the public storage system 17 and may also read data from the public storage system 17. In actual applications, the server 15 and the public storage system 17 may belong to a same cloud platform service provider or equipment provider. Theoretically, the data stored in the public storage system 17 may be acquired by the cloud platform service provider or equipment provider. At the same time, the cloud platform service provider or equipment provider may also leak the data stored in the public storage system 17, to allow a third-party user to also obtain data stored in the public storage system 17. As a result, the security level of the data stored in the public storage system 17 is low. For some operation data of the UAV, such as image data or video data captured by the photographing device 111, the data is sensitive and needs to be kept private. The existing storage mechanism does not have the capacity to guarantee the security of the data. In order to solve this problem, the disclosed embodiments provide a data transmission method to improve data security. The data transmission method will be described hereinafter with reference to specific embodiments.

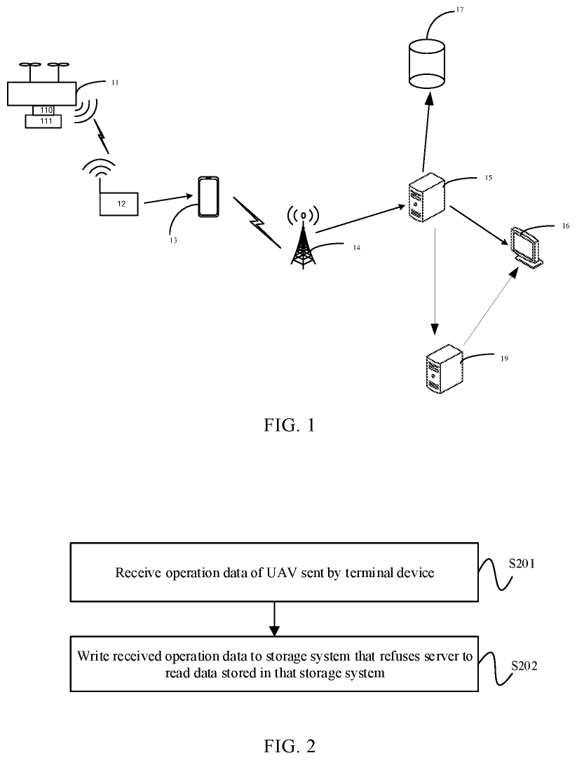

An embodiment of the present disclosure provides a data transmission method. FIG. 2 is a flowchart of a data transmission method according to an embodiment of the present disclosure. The data transmission method provided in the disclosed embodiment is applied to a server. As shown in FIG. 2, the method in the disclosed embodiment may include:

Step S201: Receive operation data of a UAV sent by a terminal device.

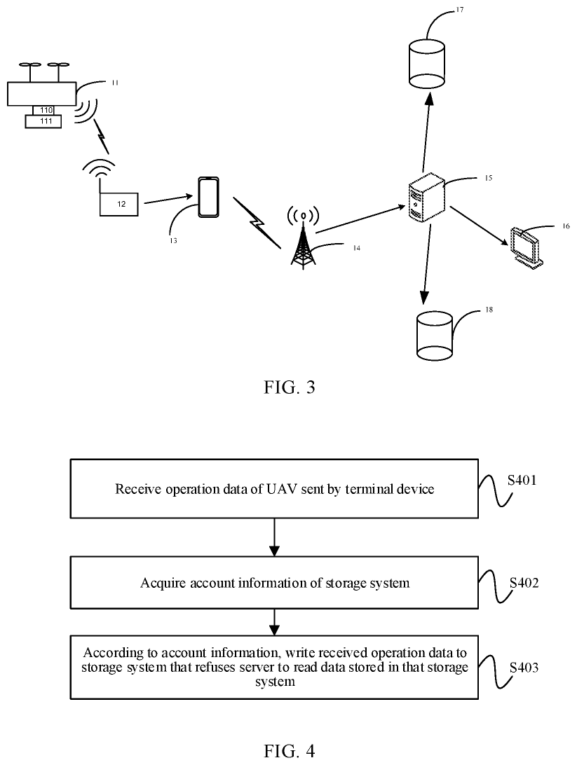

The execution entity of the method in the disclosed embodiment may be a server 15 as shown in FIG. 3. The terminal device may be a ground terminal device 13 or a remote terminal device 16.

Specifically, the server 15 may receive the operation data of the UAV sent by the terminal device 13. Optionally, the operation data includes data acquired in real time by a UAV that is communicatively connected to the terminal device. Optionally, the data acquired by the UAV in real time includes image data captured in real time by the photographing device on the UAV.

As shown in FIG. 3, when the UAV 11 performs a task assigned by the user, the photographing device 111 captures and acquires image data or video data in real time. Optionally, the UAV 11 encodes the image data or video data acquired in real time by the photographing device 111 to obtain encoded image data or encoded video data, and sends the encoded image data or encoded video data to the remote control 12 on the ground. The remote control 12 sends the encoded image data or encoded video data to the terminal device 13. Alternatively, the UAV 11 may directly send the encoded image data or encoded video data to the terminal device 13.

After receiving the encoded image data or encoded video data, the terminal device 13 may decode the encoded image data or encoded video data to obtain decoded image data or decoded video data. Next, the terminal device 13 may also encode the decoded image data or decoded video data into image data or video data in different formats. For example, the terminal device 13 encodes the decoded image data or decoded video data into image data or video data in the RTMP format.

It is to be understood that the terminal device 13 and the base station 14 may communicate through various network protocols. The preset network protocols may include one or more of a plurality of network protocols. The terminal device 13 communicates with the base station 14 according to the preset network protocol(s), to ensure the accuracy in transmitting the encoded image data or encoded video data. In some embodiments, the preset network protocol(s) includes an RTMP network protocol. It is to be understood that the RTMP network protocol is a real-time messaging protocol. Transmission of the image data or video data using the RTMP network protocol may allow the image data or vide data to be transmitted to the server 15 in real time, so that the remote terminal device 16 may also acquire the image data or video data in real time.

In some embodiments, the operation data includes route data of a UAV. For example, as shown in FIG. 3, the operator of the UAV 11, that is, the pilot of the UAV 11, may edit the route of the UAV 11 on the terminal device 13, and control the UAV 11 to fly according to the edited route. The terminal device 13 may send the route data to the server 15. Specifically, the terminal device 13 may send the route data of the UAV 11 to the server 15 through the base station 14. Alternatively, a user of the UAV 11 may also edit the route data of the UAV 11 through the remote terminal device 16. The remote terminal device 16 sends the route data of the UAV 11 edited by the user to the server 15, and the server 15 further sends the user-edited route data of the UAV 11 to the terminal device 13. The terminal device 13 sends the edited route data of the UAV 11 to the remote control 12, to allow the remote control 12 to control the flight of the UAV 11 according to the route data of the UAV 11 edited by the user. Optionally, during the operation of the UAV 11, the route data of the UAV 11 may be dynamically updated and modified.

Step S202: Write the received operation data to a storage system that refuses the server to read data stored in that storage system.

In the disclosed embodiment, when the server 15 receives operation data of a UAV, the server 15 stores the operation data of the UAV in a private storage system 18. The private storage system 18 is a storage system that refuses the server to read data stored therein. The private storage system 18 may be a storage system provided or requested by a user. The server 15 and the private storage system 18 belong to different service providers or equipment providers. The user may configure the storage system, to allow the server to write data to the storage system, but refuse the server to read the stored therein. In this way, the server 15 does not have all the privileges for the private storage system 18. For example, the server 15 may only write data into the private storage system 18, but cannot read data stored in the private storage system 18. The private storage system 18 refuses the server 15 to read the data stored therein. That is, the server 15 may only write the operation data of the UAV it has received into the private storage system 18.

Optionally, where writing the received operation data to a storage system that refuses the server to read the data stored therein includes the following possible implementations:

Implementation 1: writing the received operation data to a preset storage area of the storage system, where the preset storage area is a storage area, in the storage system, that refuses the server to read the data stored therein. Since the private storage system 18 is provided or requested by a user, rather than the service provider or equipment provider of the server 15, the account name and password (account & key, AK value) of the private storage system 18 is kept by the user. No one else may view. The server 15 cannot access all the storage space of the private storage system 18. The server 15 may write the operation data of the UAV it receives to the preset storage area in the private storage system 18. The preset storage area is a storage area, in the private storage system 18, that refuses the server to read data stored therein.

Implementation II: writing the received operation data to a storage system that refuses the server to read the operation data stored therein. Optionally, after the server 15 writes the operation data of the UAV it receives into the private storage system 18, the private storage system 18 refuses the server 15 to read the operation data stored in the private storage system 18, and may also refuse the server 15 to read other operation data stored in the private storage system 18.

In the disclosed embodiment, the server receives the operation data of the UAV sent by the terminal device, and writes the operation data to a private storage system provided by the user. The private storage system is a storage system that refuses the server to read the data stored therein. Because the server does not have all the privileges for the private storage system, it may only perform operations that write the operation data to the storage system, but cannot perform operations that read the operation data from the storage system. Accordingly, the server cannot obtain data stored in the private storage system, thereby improving data security.

An embodiment of the present disclosure provides a data transmission method. FIG. 4 is a flowchart of a data transmission method according to an embodiment of the present disclosure. As shown in FIG. 4, based on the embodiment shown in FIG. 1, the method in the disclosed embodiment may include:

Step S401: Receive operation data of a UAV sent by a terminal device.

The specific principles and implementations of Step S401 are consistent with Step S201, details of which are not described herein again.

Step S402: Acquire account information of the storage system.

Optionally, the account information includes a sub-account name and a sub-password of the storage system configured by the user.

In the disclosed embodiment, the user may configure account information of the private storage system 18, such as a sub-account name and a sub-password. In addition, the user may also configure the write-only permission of the server 15 to the sub-account. Optionally, the user may register account information with the server 15 through a ground terminal device or a remote terminal device, and the server 15 may save the account information. The account information may include user information, UAV information, sub-account name and sub-password, and write-only permission, etc. The user information may specifically be related information of the user, and the UAV information may specifically be a serial number of the UAV, product information, and the like.

When the server 15 receives the operation data of the UAV, the server queries the account information registered with the server 15 by the user.

Step S403: Write the received operation data to a storage system that refuses the server to read data stored in that storage system according to the account information.

The server 15 writes the received operation data of the UAV into the private storage system 18 according to the account information registered by the user. For example, the server 15 determines the address information of the private storage system 18 according to the sub-account name and sub-password in the account information, and writes the received operation data of the UAV to the sub-account of the private storage system 18 according to the address information. After the server 15 acquires the write-only permission information in the account information, the server 15 may recognize that the private storage system 18 is a storage system that refuses the server to read the data stored therein.

In one embodiment, the account information includes storage instruction information, which is used to instruct the server to store the operation data of the UAV into the storage system. Accordingly, where writing the received operation data to a storage system, that refuses the server to read the data stored therein, according to the account information includes: writing the received operation data to a storage system, that refuses the server to read the data stored therein, according to the storage instruction information.

Specifically, the account information registered by the user with the server 15 may further include storage instruction information, which is used to instruct the server 15 to store the operation data of the UAV into the private storage system 18. The user may selectively configure the storage instruction information under the account information according to the security level of the operation data of the UAV. For example, if the security level of the operation data of the UAV is high and the operation data of the UAV is sensitive and confidential data, the user may configure the storage instruction in the account information. When the server 15 receives the operation data of the UAV, the server 15 queries the account information registered by the user with the server 15 or the public storage system 17. According to the storage instruction information in the account information, the server 15 writes the received operation data of the UAV into the private storage system 18. If the operation data of the UAV has a low security level and is insensitive, the user may not configure the storage instruction information in the account information. Optionally, if the user does not configure the storage instruction information, when the server 15 receives the operation data of the UAV, the server 15 writes the operation data of the UAV it has received into the public storage system 17.

In the disclosed embodiment, the server receives the operation data of the UAV sent by the terminal device, and according to the account information of the private storage system, writes the operation data of the UAV it receives into the private storage system. This further improves data storage security.

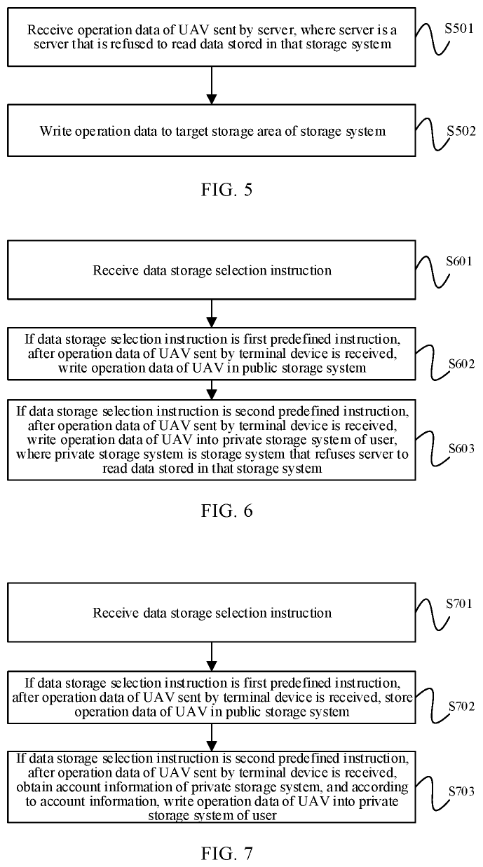

An embodiment of the present disclosure provides a data transmission method. FIG. 5 is a flowchart of a data transmission method according to another embodiment of the present disclosure. The data transmission method provided by the disclosed embodiment is applied to a storage system. As shown in FIG. 5, the data transmission method provided by the disclosed embodiment may include:

Step S501: Receive operation data of a UAV sent by a server, where the server is a server that is refused to read data stored in a storage system.

The execution entity of the method in the disclosed embodiment may be a private storage system 18 as shown in FIG. 3. The private storage system 18 may be a storage system including one or more servers, or a storage system including a distributed server cluster.

When the server 15 receives the operation data of the UAV, the server 15 stores the operation data of the UAV in the private storage system 18, which is a storage system that refuses the server to read the data stored therein. The private storage system 18 may be a storage system provided or requested by a user. The server 15 and the private storage system 18 belong to different service providers or equipment providers.

Optionally, the server 15 is a server that is refused to read the operation data of the UAV stored in a storage system. Specifically, the server 15 is a server that is refused to read the operation data of the UAV stored in the private storage system 18.

Optionally, the operation data includes data acquired in real time by the UAV. Optionally, the data acquired by the UAV in real time includes image data acquired by the photographing device on the UAV in real time. As shown in FIG. 3, when the UAV 11 performs a task assigned by the user, the photographing device 111 captures and acquires image data or video data in real time. The image data or video data captured and acquired in real time by the photographing device 111 may be considered as the operation data.

In some embodiments, the operation data includes route data of the UAV. For example, as shown in FIG. 3, the remote control 12 or the UAV 11 may store route data in advance, so that the UAV 11 may fly according to a predefined route. The remote control 12 or the UAV 11 may send the route data to the terminal device 13, which may further send the route data of the UAV 11 to the server 15 through the base station 14. Alternatively, the user of the UAV 11 may also edit the route data of the UAV 11 through the remote terminal device 16. The remote terminal device 16 sends the route data of the UAV 11 edited by the user to the server 15, and the server 15 further sends the user-edited route data of the UAV 11 to the terminal device 13. The terminal device then sends the edited route data of the UAV 11 to the remote control 12, to allow the remote control 12 to control the flight of the UAV 11 according to the route data of the UAV 11 that has been edited by the user. Optionally, during the operation of the UAV 11, the route data of the UAV 11 may be dynamically updated and modified.

Step S502: Write the operation data to a target storage area of the storage system.

When the private storage system 18 receives the operation data of the UAV sent by the server 15, the private storage system 18 writes the operation data into a target storage area of the private storage system 18. The target storage area may be a preset storage area in the private storage system 18. The preset storage area may be used to store the operation data of the UAV of the user.

In the disclosed embodiment, through receiving the operation data of the UAV, sent by the server, via the private storage system, the server may only write data to the private storage system, but is refused to read data stored in the private storage system. Since the server does not have all the privileges for the private storage system, the server may only perform operations that write the operation data to the storage system, but cannot perform operations that read the operation data. Accordingly, the server cannot obtain the data stored in the private storage system, which then improves data security.

An embodiment of the present disclosure provides a data transmission method. FIG. 6 is a flowchart of a data transmission method according to another embodiment of the present disclosure. The data transmission method provided by the disclosed embodiment is applied to a server. As shown in FIG. 6, the data transmission method provided by the disclosed embodiment may include:

Step S601: Receive a data storage selection instruction.

The execution entity of the method in the disclosed embodiment may be the server 15 as shown in FIG. 3. In the disclosed embodiment, the terminal device 13 may send a data storage selection instruction to the server 15 through the base station 14. In addition, the remote terminal device 16 may also send a data storage selection instruction to the server 15. Further, another device may also send a data storage selection instruction to the server 15, as long as the other device may detect a data storage selection operation of a user, generate the data storage selection instruction according to the data storage selection operation of the user, and send the generated data storage selection instruction to the server 15.

The data storage selection instruction is used to instruct the server 15 to store the operation data of the UAV in the private storage system 18 or in the public storage system 17. Optionally, the data storage selection instruction may specifically be a first predefined instruction or a second predefined instruction. The first predefined instruction is used to instruct the server 15 to store the operation data of the UAV in the public storage system 17. The second predefined instruction is used to instruct the server 15 to store the operation data of the UAV in the private storage system 18.

It is to be understood that the server 15 has all the privileges for the public storage system 17. For instance, the server 15 may access all the storage area of the public storage system 17. The server 15 may write data to the public storage system 17 and may also read data from the public storage system 17. In actual applications, the server 15 and the public storage system 17 may belong to the same cloud platform service provider or equipment provider.

The private storage system 18 is a storage system that refuses the server 15 to read the data stored therein. The private storage system 18 may be a storage system provided by a user, and the server 15 and the private storage system 18 may belong to different service providers or equipment providers.

Step S602: If the data storage selection instruction is a first predefined instruction, after the operation data of the UAV sent by the terminal device is received, store the operation data of the UAV in a public storage system.

If the safety level of the operation data of the UAV is low and is insensitive data, the data storage selection instruction sent to the server 15 by the terminal device 13 or the remote terminal device 16 is a first predefined instruction. When the server 15 receives the image data or video data captured by the photographing device of the UAV sent by the terminal device 13, the server 15 stores the image data or video data in the public storage system 17. Alternatively, when the server 15 receives the route data of the UAV sent by the terminal device 13 or the remote terminal device 16, the server 15 stores the route data in the public storage system 17.

Step S603: If the data storage selection instruction is a second predefined instruction, after the operation data of the UAV sent by the terminal device is received, write the operation data of the UAV into the private storage system of the user, where the private storage system is a storage system that refuses the server to read data stored in that storage system.

If the operation data of the UAV has a high security level and is sensitive and confidential data, the data storage selection instruction sent to the server 15 by the terminal device 13 or the remote terminal device 16 is a second predefined instruction. When the server 15 receives the image data or video data captured by the photographing device of the UAV sent by the terminal device 13, the server 15 stores the image data or video data in the private storage system 18. Alternatively, when the server 15 receives the route data of the UAV sent by the terminal device 13 or the remote terminal device 16, the server 15 stores the route data in the private storage system 18.

Optionally, where writing the operation data of the UAV into the private storage system of the user includes the following possible implementations:

Implementation 1: writing the operation data of the UAV into a preset storage area of the private storage system of the user, where the preset storage area is a storage area in the private storage system that refuses the server to read the data stored therein. For example, the server 15 may write the operation data of the UAV it receives to a preset storage area in the private storage system 18, where the preset storage area is a storage area, in the private storage system 18, that refuses the server 15 to read the data stored therein.

Implementation 2: writing the operation data of the UAV to a private storage system that refuses the server to read the operation data stored therein. Optionally, after the server 15 writes the operation data of the UAV it receives into the private storage system 18, the private storage system 18 refuses the server 15 to read the operation data stored in the private storage system 18.

Optionally, the operation data includes data acquired in real time by a UAV that is communicatively connected to the terminal device. Specifically, the data acquired by the UAV in real time includes image data acquired by the photographing device on the UAV in real time.

In some embodiments, the operation data includes route data of the UAV.

In the disclosed embodiment, the server receives a data storage selection instruction, and selectively stores the operation data of the UAV in a public storage system or a private storage system according to the data storage selection instruction. This improves data storage security and data storage flexibility.

An embodiment of the present disclosure provides a data transmission method. FIG. 7 is a flowchart of a data transmission method according to another embodiment of the present disclosure. The data transmission method provided in the embodiment of the present disclosure is applied to a server. As shown in FIG. 7, based on the embodiment shown in FIG. 6, the method may include:

Step S701: Receive a data storage selection instruction.

The specific principles and implementations of Step S701 are consistent with Step S601, details of which are not described herein again.

Step S702: If the data storage selection instruction is a first predefined instruction, after the operation data of the UAV sent by the terminal device is received, store the operation data of the UAV in a public storage system.

The specific principles and implementations of Step S702 are consistent with Step S602, details of which are not described herein again.

Step S703: If the data storage selection instruction is a second predefined instruction, after the operation data of the UAV sent by the terminal device is received, obtain the account information of the private storage system, and write the operation data of the UAV into the private storage system of the user according to the account information.

If the operation data of the UAV has a high security level and is sensitive and confidential data, the data storage selection instruction sent to the server 15 by the terminal device 13 or the remote terminal device 16 is a second predefined instruction. When the server 15 receives the image data or video data captured by the UAV photographing device sent by the terminal device 13, the server 15 obtains the account information of the private storage system 18. A user may register the account information of the private storage system 18 with the server 15. Optionally, the account information includes a sub-account name and a sub-password of the private storage system configured by the user. Accordingly, the server 15 stores the image data or video data in the private storage system 18 according to the sub-account name and sub-password of the private storage system 18.

Alternatively, when the server 15 receives the route data of the UAV sent by the terminal device 13 or the remote terminal device 16, the server 15 obtains the account information of the private storage system 18. According to the sub-account name and sub-password of the private storage system 18, the server 15 stores the route data in the private storage system 18.

In the disclosed embodiment, the server receives a data storage selection instruction, and selectively stores the operation data of the UAV in a public storage system or in the private storage system according to the data storage selection instruction. This improves data storage security and data storage flexibility. In addition, if the data storage selection instruction instructs the server to store the operation data of the UAV in a private storage system, when the server receives the operation data of the UAV, the server stores the operation data of the UAV in the private storage system according to the account information of the private storage system, which further improves the data storage security.

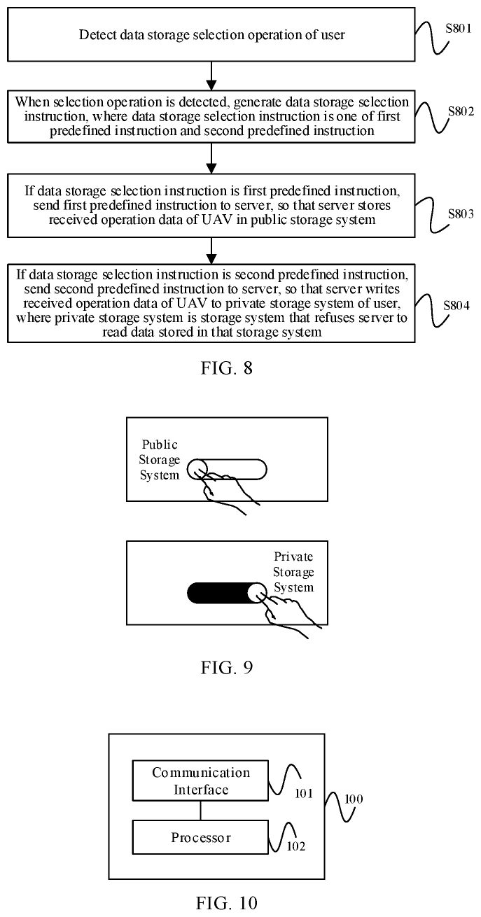

An embodiment of the present disclosure provides a data transmission method. FIG. 8 is a flowchart of a data transmission method according to another embodiment of the present disclosure. The data transmission method provided by the disclosed embodiment is applied to a terminal device. As shown in FIG. 8, the method includes:

Step S801: Detect a data storage selection operation of a user.

The execution entity of the method in the disclosed embodiment may be a terminal device 13 or a remote terminal device 16 as shown in FIG. 3. A user may select the storage system for storing the operation data of the UAV through the terminal device 13 or the remote terminal device 16. For example, an application program is installed on the terminal device 13 or the remote terminal device 16. The application program has a corresponding user interface. The user may operate on the user interface to select a storage system for storing the operation data of the UAV. The application detects the data storage selection of the user. For example, the user interface is provided with a slide button, and the data storage selection operation may be a slide operation of the slide button. As shown in FIG. 9, when the slide button is slid to the left end, it means that the storage system for storing the operation data of the UAV is a public storage system. When the slide button is slid to the right end, it means that the storage system for storing the operation data of the UAV is a private storage system. The description above is merely for illustrative purposes, but does not limit the specific user interface and the way of data storage selection operations.

Step S802: When the selection operation is detected, generate a data storage selection instruction, where the data storage selection instruction is one of a first predefined instruction and a second predefined instruction.

When the application detects that the user has performed a slide operation on the slide button, a data storage selection instruction is generated. The data storage selection instruction is either a first predefined instruction or a second predefined instruction. Optionally, when the application detects that the user slides the slide button to the left end, a first predefined instruction is generated. When the application detects that the user slides the slide button to the right end, a second predefined instruction is generated.

Step S803: If the data storage selection instruction is the first predefined instruction, send the first predefined instruction to the server, so that the server stores the received operation data of the UAV in a public storage system.

When the application detects that the user has slide the slide button to the left end, the application generates a first predefined instruction and sends the first predefined instruction to the server 15. When the server 15 receives the operation data of the UAV, the server 105 stores the operation data of the UAV in the public storage system 17.

Step S804: If the data storage selection instruction is a second predefined instruction, send the second predefined instruction to the server, so that the server writes the received operation data of the UAV to the private storage system of the user, where the private storage system is a storage system that refuses the server to read data stored therein.

When the application detects that the user has slide the slide button to the right end, the application generates a second predefined instruction and sends the second predefined instruction to the server 15. When the server 15 receives the operation data of the UAV, the servers stores the operation data of the UAV in the private storage system 18.

In addition, another device may send a data storage selection instruction to the server 15, as long as the other device may detect a data storage selection operation of a user, generate a data storage selection instruction according to the data storage selection operation of the user, and send the data storage selection instruction to the server 15.

In some embodiments, the method further includes: sending the operation data of the UAV to the server.

Optionally, the operation data includes data acquired in real time by a UAV that is communicatively connected to the terminal device. Specifically, the data acquired by the UAV in real time includes image data acquired by the photographing device on the UAV in real time.

In some embodiments, the operation data includes route data of the UAV.

For example, the terminal device 13 may send image data or video data captured by the photographing device of the UAV, or route data of the UAV, to the server 15. The remote terminal device 16 may send the route data of the UAV to the server 15.

In the disclosed embodiment, the data storage selection operation of a user is detected by the terminal device, and a data storage selection instruction is generated according to the data storage selection operation. The data storage selection instruction is sent to the server, to allow the server to selectively store the operation data of the UAV in a public storage system or in the private storage system according to the data storage selection instruction. This improves data storage security and data storage flexibility.

An embodiment of the present disclosure provides a server. FIG. 10 is a structural diagram of a server according to an embodiment of the present disclosure. As shown in FIG. 10, the server 100 includes a communication interface 101 and a processor 102. The communication interface 101 is configured to receive the operation data of the UAV sent by the terminal device. The processor 102 is configured to write the received operation data through the communication interface 101 to a storage system that refuses the server to read the data stored therein.

Optionally, when writing the received operation data through the communication interface 101 to a storage system that refuses the server to read the data stored therein, the processor 102 is specifically configured to: write the received operation data through the communication interface 101 to a preset storage area of a storage system, where the preset storage area is a storage area, in the storage system, that refuses the server to read the data stored therein.

Optionally, when writing the received operation data through the communication interface 101 to a storage system that refuses the server to read the data stored therein, the processor 102 is specifically configured to: write the received operation data into a storage system that refuses the server to read operation data stored therein.

Optionally, the operation data includes data acquired in real time by a UAV that is communicatively connected to the terminal device.

Optionally, the data acquired by the UAV in real time includes image data acquired by the photographing device on the UAV in real time.

Optionally, the operation data includes route data of the UAV.

Optionally, the processor 102 is further configured to: obtain account information of the storage system. When writing the received operation data through the communication interface 101 to a storage system that refuses the server to read the data stored therein, the processor 102 is specifically configured to: write the received operation data through the communication interface 101 to the storage system that refuses the server to read the data stored therein according to the account information.

Optionally, the account information includes a sub-account name and a sub-password of the storage system configured by the user.

Optionally, the account information includes storage instruction information. The storage instruction information is used to instruct the server to store the operation data of the UAV in the storage system. Accordingly, when writing the received operation data through the communication interface 101 to a storage system that refuses the server to read the data stored therein, the processor 102 is specifically configured to: according to the storage instruction information, write the received operation data through the communication interface 101 to the storage system that refuses the server to read the data stored therein.

The specific principles and implementations of the server provided by the disclosed embodiment are similar to the embodiments shown in FIG. 2 to FIG. 4, details of which are not described herein again.

In the disclosed embodiment, the server receives the operation data of the UAV sent by the terminal device, and writes the operation data to a private storage system provided by the user. The private storage system is a storage system that refuses the server to read the data stored therein. Because the server does not have all the privileges for the private storage system, the server may only perform operations that write the operation data to the storage system, but cannot perform operations that read the operation data. Accordingly, the server cannot obtain data stored in the private storage system, which improves data security. The server receives the operation data of the UAV sent by the terminal device, and writes the operation data of the UAV it receives into the private storage system according to the account information of the private storage system, which further improves the data storage security.

An embodiment of the present disclosure provides a storage system. FIG. 11 is a structural diagram of a storage system according to an embodiment of the present disclosure. As shown in FIG. 11, the storage system 1100 includes a communication interface 1101 and a processor 1102. The communication interface 1101 is configured to receive the operation data of the UAV sent by the server, where the server is a server that is refused to read the data stored in the storage system. The processor 1102 is configured to write the operation data to a target storage area of the storage system.

Optionally, the server is a server that is refused to read the operation data of the UAV stored in the storage system.

Optionally, the operation data includes data acquired in real time by the UAV.

Optionally, the data acquired by the UAV in real time includes image data acquired by the photographing device on the UAV in real time.

Optionally, the operation data includes route data of the UAV.

The specific principles and implementations of the storage system provided by the disclosed embodiment are similar to the embodiment shown in FIG. 5, detail of which are not repeated here.

In the disclosed embodiment, the operation data of the UAV sent by the server is received through the private storage system. The server may only write data to the private storage system, but is refused to read the data stored in the private storage system. Since the server does not have all the privileges for the private storage system, the server may only perform the operations that write the operation data to the storage system, and cannot perform the operations that read the operation data. Accordingly, the server cannot obtain the data stored in the private storage system, which improves data security.

An embodiment of the present disclosure provides a server. FIG. 12 is a structural diagram of a server according to another embodiment of the present disclosure. As shown in FIG. 12, the server 1200 includes a communication interface 1201 and a processor 1202. The communication interface 1201 is configured to receive a data storage selection instruction. The processor 1202 is configured to determine whether the data storage selection instruction is a first predefined instruction or a second predefined instruction. If the data storage selection instruction is a first predefined instruction, after the processor 1202 receives the operation data of the UAV sent by the terminal device through the communication interface 1201, the operation data of the UAV is stored in a public storage system through the communication interface 1201. If the data storage selection instruction is a second predefined instruction, after the processor 1202 receives the operation data of the UAV sent by the terminal device through the communication interface 1201, the operation data of the UAV is written into the private storage system of the user through the communication interface 1201. The private storage system is a storage system the refuses the server to read the data stored therein.

Optionally, when writing the operation data of the UAV into the private storage system of the user through the communication interface 1201, the processor 1202 is specifically configured to: write the operation data of the UAV through the communication interface 1201 to a preset storage area of the private storage system of the user, where the preset storage area is a storage area, in the private storage system, that refuses the server to read data stored therein.

Optionally, when writing the operation data of the UAV through the communication interface 1201 to the private storage system of the user, the processor 1202 is specifically configured to: write the operation data of the UAV through the communication interface 1201 to a private storage system that refuses the server to read operation data stored therein.

Optionally, the operation data includes data acquired in real time by a UAV that is communicatively connected to the terminal device.

Optionally, the data acquired by the UAV in real time includes image data acquired by the photographing device on the UAV in real time.

Optionally, the operation data includes route data of the UAV.

Optionally, the processor 1202 is further configured to: obtain account information of the private storage system. When writing the operation data of the UAV through the communication interface 1201 to the private storage system of the user, the processor 1202 is specifically configured to: write the operation data of the UAV through the communication interface 1201 to the private storage system of the user according to the account information.

Optionally, the account information includes a sub-account name and a sub-password of the private storage system configured by the user.

The specific principles and implementations of the server provided by the disclosed embodiment are similar to the embodiment shown in FIG. 6 or FIG. 7, details of which are not described herein again.

In the disclosed embodiment, the server receives a data storage selection instruction, and selectively stores the operation data of the UAV in a public storage system or in the private storage system according to the data storage selection instruction. This improves data storage security and data storage flexibility. In addition, if the data storage selection instruction instructs the server to store the operation data of the UAV in a private storage system, when the server receives the operation data of the UAV, the server stores the operation data of the UAV according to the account information of the private storage system, which further improves the data storage security.

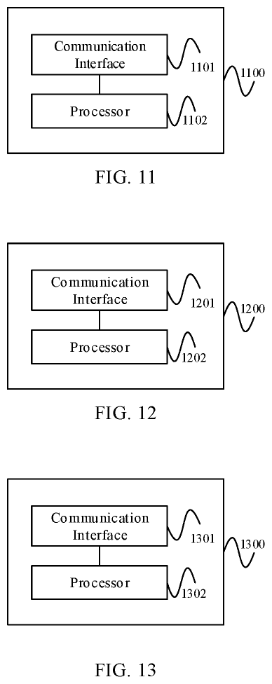

An embodiment of the present disclosure provides a terminal device. FIG. 13 is a structural diagram of a terminal device according to an embodiment of the present disclosure. As shown in FIG. 13, the terminal device 1300 includes a communication interface 1301 and a processor 1302. The processor 1302 is configured to detect a data storage selection operation of a user. When the selection operation is detected, a data storage selection instruction is generated, where the data storage selection instruction is either a first predefined instruction or a second predefined instruction. If the data storage selection instruction is a first predefined instruction, the first predefined instruction is sent to the server through the communication interface 1301, so that the server stores the received operation data of the UAV in a public storage system. If the data storage selection instruction is a second predefined instruction, the second predefined instruction is sent to the server through the communication interface 1301, so that the server writes the received operation data of the UAV into the private storage system of the user. The private storage system is a storage system that refuses the server to read data stored therein.

Optionally, the communication interface 1301 is further configured to: send the operation data of the UAV to the server.

Optionally, the operation data includes data acquired in real time by a UAV that is communicatively connected to the terminal device.

Optionally, the data acquired by the UAV in real time includes image data acquired by the photographing device on the UAV in real time.

Optionally, the operation data includes route data of the UAV.

The specific principles and implementations of the terminal device provided by the disclosed embodiment are similar to the embodiment shown in FIG. 8 or FIG. 9, details of which are not described herein again.

In the disclosed embodiment, the data storage selection operation of the user is detected by the terminal device, and a data storage selection instruction is generated according to the data storage selection operation. The data storage selection instruction is sent to the server, to allow the server to selectively store the operation data of the UAV in a public storage system or in the private storage system according to the data storage selection instruction, which improves data storage security and data storage flexibility.

An embodiment of the present disclosure provides a data transmission system. The data transmission system includes a server 100 shown in FIG. 10 or a server 1200 shown in FIG. 12, a storage system 1100 shown in FIG. 11, and a terminal device 1300 shown in FIG. 13.

In the embodiments provided by the present disclosure, it should be noted that the disclosed systems, devices, and methods may be implemented in other ways. For example, the device embodiments described above are merely for illustrative purposes. For example, the division of the units is only a logical function division. In actual implementations, there may be alternative ways to divide the units. For example, multiple units or components may be combined or may be integrated into another system, or some features may be ignored or not implemented. In addition, the displayed or described mutual couplings or direct couplings or communication connections may be indirect couplings or communication connections through some interfaces, devices or units, and may be in the electrical, mechanical or other forms.

The units described as separate components may or may not be physically separated. The components displayed as units may or may not be physical units, that is, may be located in one place, or may be distributed on multiple network units. Some or all of the units may be selected according to actual needs to achieve the objective of the solutions of the disclosed embodiments.

Further, each functional unit in each embodiment of the present disclosure may be integrated into one processing unit, or each unit may be a physical unit that exists separately, or two or more units may be integrated into one unit. The integrated units may be implemented in the form of hardware, or in the form of hardware plus software functional units.

The integrated units implemented in the form of software functional units may be stored in a computer-readable storage medium. The software functional units are stored in a storage medium and include a series of instructions that cause a computer device (which may be a personal computer, a server, or a network device) or a processor to execute certain steps of the methods described in the embodiments of the present disclosure. The foregoing storage medium includes a jump drive, a portable hard drive, a read-only memory (ROM), a random-access memory (RAM), a magnetic disk, an optical disk, or other media that may store program codes.

Those skilled in the art may clearly understand that for the convenience and brevity of the description, only the aforementioned division of the functional modules is taken as an example. In practical applications, the aforementioned functions may be allocated by different functional modules according to the actual needs. That is, the internal structure of a device may be divided into different functional modules to complete all or part of the functions described above. For the specific operation processes of the devices described above, may refer to the corresponding processes in the foregoing method embodiments, details of which are not described herein again.

Further, it should be noted that the above embodiments are merely used to illustrate the technical solutions of the present disclosure, but are not limited thereto. Although the present disclosure has been described in detail with reference to the foregoing embodiments, those skilled in the art may appreciate that the technical solutions described in the foregoing embodiments may still be modified, or some or all of the technical features may be equivalently substituted. These modifications or substitutions do not deviate the spirits and principles of the corresponding technical solutions from the coverage of the technical solutions of the embodiments of the present disclosure.

What is claimed is:

1. A data transmission method applied to a server, comprising:
receiving operation data of an unmanned aerial vehicle (UAV) sent by a terminal device; and
writing the received operation data to a storage system that refuses the server to read data stored in that storage system.

2. The method according to claim 1, wherein writing the received operation data to a storage system that refuses the server to read data stored in that storage system further includes:
writing the received operation data into a preset storage area of the storage system, wherein the preset storage area is a storage area, in the storage system, that refuses the server to read data stored in that storage area.

3. The method according to claim 1, wherein writing the received operation data to a storage system that refuses the server to read data stored in that storage system further includes:
writing the received operation data to a storage system that refuses the server to read the operation data stored in the storage system.

4. The method according to claim 1, wherein the operation data includes data acquired in real time by a UAV that is communicatively connected to the terminal device.

5. The method according to claim 4, wherein the data acquired by the UAV in real time includes image data acquired by a photographing device on the UAV in real time.

6. The method according to claim 1, wherein the operation data includes route data of the UAV.

7. The method according to claim 1, further comprising:
acquiring account information of the storage system; and
wherein writing the received operation data to a storage system that refuses the server to read data stored in that storage system further includes:
according to the account information, writing the received operation data to a storage system that refuses the server to read data stored in that storage system.

8. The method according to claim 7, wherein:
the account information includes a sub-account name and a sub-password of the storage system configured by a user.

9. The method according to claim 7, wherein:
the account information includes storage instruction information that is used to instruct the server to store the operation data of the UAV into the storage system; and
writing the received operation data to a storage system that refuses the server to read data stored in that storage system according to the account information further includes:
according to the storage instruction information, writing the received operation data to a storage system that refuses the server to read data stored in that storage system.

10. A server, comprising a communication interface and a processor, wherein:
the communication interface is configured to receive operation data of a UAV sent by a terminal device; and
the processor is configured to write the received operation data through the communication interface to a storage system that refuses the server to read data stored in that storage system.

11. The server according to claim 10, wherein, when writing the received operation data through the communication interface to a storage system that refuses the server to read data stored in that storage system, the processor is further configured to:
write the received operation data through the communication interface to a preset storage area of the storage system, wherein the preset storage area is a storage area, in the storage system, that refuses the server to read data stored in that storage area.

12. The server according to claim 10, wherein, when writing the received operation data through the communication interface to a storage system that refuses the server to read data stored in that storage system, the processor is further configured to:
write the received operation data through the communication interface to a storage system that refuses the server to read the operation data stored in that storage system.

13. The server according to claim 10, wherein the operation data includes data acquired in real time by a UAV that is communicatively connected to the terminal device.

14. The server according to claim 13, wherein the data acquired by the UAV in real time includes image data acquired by a photographing device on the UAV in real time.

15. The server according to claim 10, wherein the operation data includes route data of the UAV.

16. The server according to claim 10, wherein the processor is further configured to:
acquire account information of the storage system; and
when writing the received operation data through the communication interface to a storage system that refuses the server to read data stored in that storage system, the processor is further configured to:
according to the account information, write the received operation data through the communication interface to the storage system that refuses the server to read data stored in that storage system.

17. The server according to claim 16, wherein the account information includes a sub-account name and a sub-password of the storage system configured by a user.

18. The server according to claim 16, wherein the account information includes storage instruction information that is used to instruct the server to store the operation data of the UAV into the storage system; and
when writing the received operation data through the communication interface to a storage system that refuses the server to read data stored in that storage system according to the account information, the processor is further configured to:
according to the storage instruction information, write the received operation data through the communication interface to the storage system that refuses the server to read data stored in that storage system.
